(19) United States
(12) Patent Application Publication
(10) Pub. No.: US 2014/0316599 A1
(43) Pub. Date: Oct. 23, 2014

(54) CONSUMER ENERGY MANAGEMENT SYSTEM AND CONSUMER ENERGY MANAGEMENT METHOD

(71) Applicants: Yasushi Tomita, Tokyo (JP); Masahiro Watanabe, Tokyo (JP); Takanori Ninomiya, Tokyo (JP)

(72) Inventors: Yasushi Tomita, Tokyo (JP); Masahiro Watanabe, Tokyo (JP); Takanori Ninomiya, Tokyo (JP)

(73) Assignee: HITACHI, LTD., Tokyo (JP)

(21) Appl. No.: 14/359,339

(22) PCT Filed: Nov. 29, 2011
(86) PCT No.: PCT/JP2011/077576

§ 371 Date: May 20, 2014

(51) Int. Cl. G05F 1/66

(52) U.S. Cl. CPC G05F 1/66
USPC 700/295

(57) ABSTRACT

The present invention adjusts the operating status of consumer devices in a manner meeting the consumer's needs when the electric power usable by the consumer is limited. There are provided: an information acquisition part (S10) which acquires operation request information indicative of requests with regard to the operating status of at least one device at predetermined intervals, and device electric power characteristic information indicative of information on the power consumed or generated by the device; a device operation pattern candidate creation part (S20) which creates a plurality of device operation pattern candidates indicative of the operating status of the device at predetermined intervals; and an evaluation part (S30) which evaluates the plurality of device operation pattern candidates on the basis of the operation request information and of the device electric power characteristic information.

### TECHNICAL FIELD

The present invention relates to a consumer energy management system and a consumer energy management method.

### BACKGROUND ART

There are growing needs for bringing about a low-carbon society or ensuring energy security in the event of disaster. With a view to meeting such needs, it has been desired to introduce energy-related equipment such as photovoltaics (called PV hereunder) and storage batteries into the consumer end that consumes electric power.

At normal times, using PV as a source of renewable energy can contribute to bringing about the low-carbon society. The power output of PV and the discharge output of storage batteries help reduce the amount of electric power supplied from the power system to consumers. If an abrupt rise in demand for power leads to a fear of insufficient supply capability, or if there is a concern that the capacity of system devices may be overwhelmed by overload, use of PV and storage batteries can temporarily reduce the amount of electric power supplied from the power system to the consumers.

If links to the power system have been severed and consumers are electrically isolated, for example, at a time of a disaster, PV facilities and storage batteries set up on their premises allow the consumers to be self-sufficient in electric energy to a certain extent.

However, since the power output of PV is contingent on weather, all the consumers' needs for electricity may not be met depending on the weather condition. In such a case, the consumers would be required to operate their equipment within the limits of electric power provided by their PV and storage batteries. Otherwise the demand for power would exceed the supply of power.

In the conventional art, the consumer's devices to be operated in case of power outage are prioritized beforehand. During power outage, high-priority devices are operated preferentially within the amount of power that can be supplied by PV and storage batteries (Patent Literature 1).

### PRIOR ART LITERATURE

### Patent Document

Patent Document 1: JP-2011-83088-A

### SUMMARY OF THE INVENTION

### Problem to be Solved by the Invention

To operate electric equipment requires supplying not only the amount of electric energy (Wh) needed by the equipment but also the amount of electric power (W) that meets the need. According to the above-cited Patent Literature, the devices to be operated are determined in accordance with the amount of power that can be supplied by PV and storage batteries.

For example, consider a case where the discharge power (W) of storage batteries is small with low solar irradiance, leading to the low electric power (W) of PV as well. In this case, the sum of the power generated by PV and the power discharged by the storage batteries is insufficient even when the storage batteries have a sufficient state of charge (Wh). Electric devices may be inoperable as a result.

Many electric devices need a larger amount of power immediately after startup than in normal operating status. Thus in determining a combination of electric devices to be operated, it is necessary to consider whether a given device is already operating or has yet to be started.

With a currently operating electric device, it is necessary to determine whether the electric device in question is operable in view of the electric power (W) or the electric energy (Wh) consumed in normal operating status. In the case of an electric device yet to be started, it is necessary to determine whether the electric device in question is operable using the electric power (W) or the electric energy (Wh) to be consumed immediately after startup.

Furthermore, the electric devices that the consumer wants to operate are different depending on the hours of the day in which the devices operate. For example, some electric devices are desired to operate during the hot hours of the day; some are desired to function at meal time in the morning and in the evening; and some, like a refrigerator, are desired to run nonstop. The consumer knows the degree of their own demand to the electric devices operating. It is, however, difficult for the consumer to determine how to establish the most appropriate pattern in which the electric devices should run.

It is therefore an object of the present invention to provide a consumer energy management system and a consumer energy management method for evaluating a plurality of device operation pattern candidates indicative of device operating status on the basis of the request of consumers. Another object of the present invention is to provide a consumer energy management system and a consumer energy management method for creating device operation patterns for operating consumer-specified devices as much as possible during the hours of the day desired by the consumer where the supply of electric power to the consumer is limited.

### Means for Solving the Problem

In solving the above-mentioned problem and according to the present invention, there is provided a consumer energy management system for managing operating status of devices possessed by a consumer, the system including: an information acquisition part which acquires operation request information indicative of requests with regard to the operating status of at least one device at predetermined intervals, and further acquires device electric power characteristic information indicative of information on the power consumed or generated by the device; a device operation pattern candidate creation part which creates a plurality of device operation pattern candidates indicative of the operating status of the device at predetermined intervals; and an evaluation part which evaluates the plurality of device operation pattern candidates on the basis of the operation request information and of the device electric power characteristic information.

There may be further included a selection part which, on the basis of the result of the evaluation, selects one of the plurality of device operation pattern candidates as the device operation pattern.

A control signal may be transmitted to the device to operate the device in accordance with the device operation pattern selected by the selection part.

At least a part of the structure of the present invention may be implemented in the form of a computer program or a hardware circuit. The computer program may be distributed via communication media such as the Internet or via recording media such as hard disk and flash memory device.

### BRIEF DESCRIPTION OF THE DRAWINGS

FIG. 1 is an explanatory drawing outlining one embodiment of the present invention.

FIG. 2 is an overall structural diagram of a power system including a consumer energy management system.

FIG. 3 is a structural diagram of the consumer energy management system.

FIG. 4 is a structural diagram of a consumer energy management apparatus.

FIG. 5 shows a composition example of a device operation pattern.

FIG. 6 shows a composition example of device operation request group data.

FIG. 7 shows results of calculating goodness of fit.

FIG. 8 shows another composition example of the device operation pattern.

FIG. 9 shows other results of calculating the goodness of fit.

FIG. 10 shows a flow of processing performed in the consumer energy management system.

FIG. 11 shows a composition example of information for managing the amount of electric power generated by PV and the amount of electric power stored per device operation pattern candidate.

FIG. 12 shows the goodness of fit of device operation pattern candidates in effect when there is a large amount of insolation.

FIG. 13 shows the goodness of fit of device operation pattern candidates in effect when there is a small amount of insolation.

FIG. 14 shows a composition example of device operation request group data regarding a second embodiment of the present invention.

FIG. 15 is a structural diagram of a consumer energy management system as a third embodiment of the present invention.

FIG. 16 is a structural diagram of a consumer energy management system as a fourth embodiment of the present invention.

FIG. 17 show a flow of processing performed in a consumer energy management system as a fifth embodiment of the present invention.

FIG. 18 shows a typical screen that prompts a consumer to select a device operation pattern.

### MODE FOR CARRYING OUT THE INVENTION

Some embodiments of the present invention will now be described using the accompanying drawings. As will be explained below in detail, the embodiments create the operation patterns of electric devices as desired by the consumer.

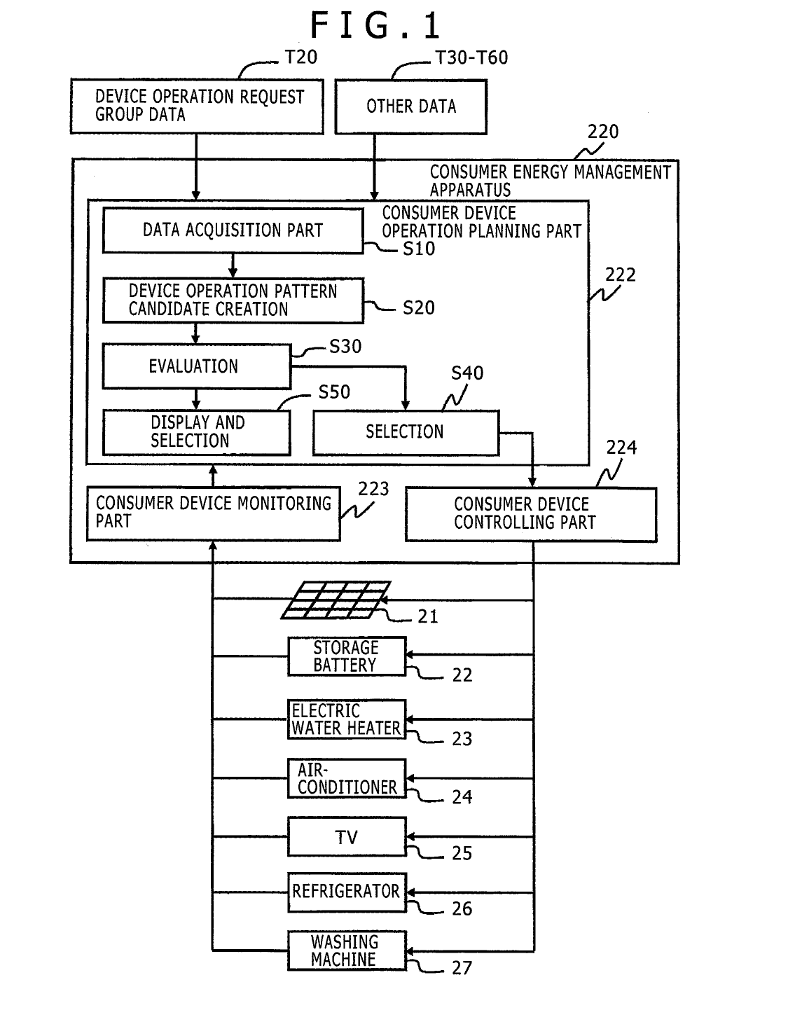

FIG. 1 is an explanatory drawing outlining one embodiment of the present invention. The technical scope of the present invention is not limited to what is shown in FIG. 1 and in the subsequent drawings. All applications conforming to the principles of the present invention are included in the technical scope thereof. When some of the components are removed from the setup in FIG. 1, the resulting configuration is still included in the technical scope of the present invention. When some other components are added to the setup in FIG. 1, the resulting configuration is also included in the technical scope of this invention.

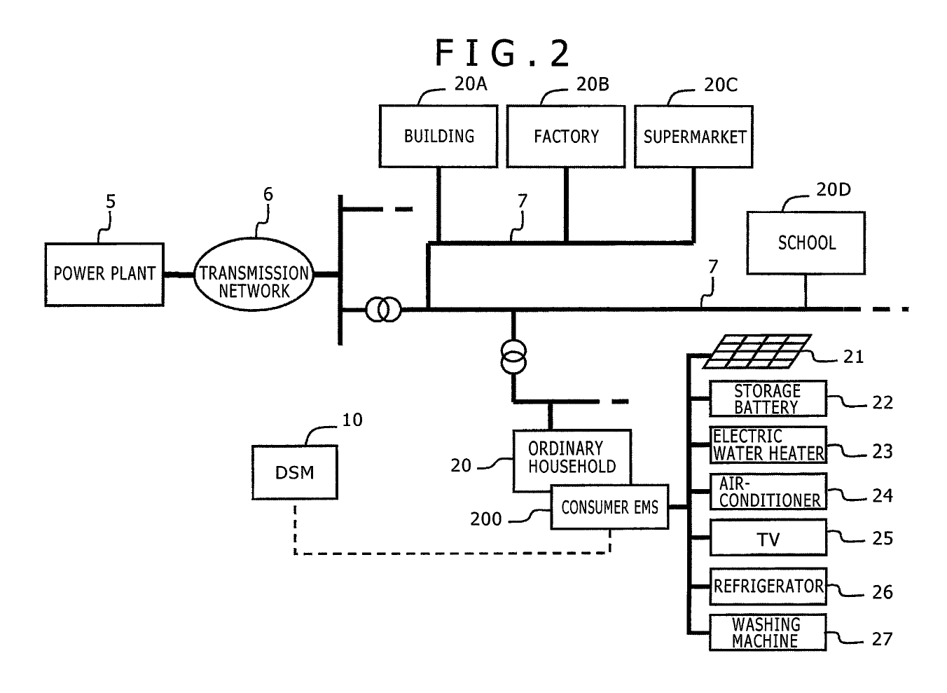

Each of the components will be discussed later in detail with reference to FIG. 2 and the subsequent drawings. Referring to FIG. 1, an overall configuration of the consumer energy management system is briefly explained.

A consumer energy management apparatus 220 constituting the core of the consumer energy management system is configured with a computer system. The consumer energy management apparatus 220 is connected to electric devices 21 through 27 possessed by the consumer. Each of the electric devices 21 through 27 will be discussed later in detail.

The consumer energy management apparatus 220 includes a consumer device operation planning part 222, a consumer device monitoring part 223, and a consumer device controlling part 224, for example. The consumer device monitoring part 223 monitors the operating status of the consumer's electric devices 21 through 27.

The consumer device operation planning part 222 creates device operation patterns that prescribe the operating status of the respective consumers' electric devices. In the ensuing description, the consumer device operation planning part 222 may be abbreviated as the operation planning part 222. The device operation pattern may be created at intervals of a control time. That is, the device operation pattern, after being created, may be revised and updated at every control time.

The operation planning part 222 uses a data acquisition part (S10) to acquire device operation request group data T20 and other data T30 through T60. The device operation request group data T20 is information which allows the consumer to manage when and how to use which electric device (consumer use needs) and corresponds to “operation request information.” The other data T30 through T60 correspond to “device electric power characteristic information.”

The operation planning part 222 uses a device operation pattern candidate creation part (S20) to create a plurality of electric device operation pattern candidates.

The operation planning part 222 uses an evaluation part (S30) to evaluate each of the plurality of device operation pattern candidates. On the basis of the result of the evaluation, a selection part (S40) in the operation planning part 222 automatically selects one of the plurality of device operation pattern candidates. The selected pattern is called device operation pattern. For example, the highest-evaluated device operation pattern candidate may be selected.

The consumer device controlling part 224 transmits predetermined control signals to each of the electric devices at predetermined timings to operate the devices in accordance with the device operation pattern.

Alternatively, the device operation pattern may be selected not automatically but by the consumer. In this case, the operation planning part 222 presents the consumer with a plurality of device operation pattern candidates via a display and selection part (S50). The consumer selects one of the device operation pattern candidates as the device operation pattern via the display and selection part (S50). The consumer may t, select the device operation pattern either by referencing the result of the evaluation by the evaluation part (S30) or without regard to the result of the evaluation.

Also, whether the device operation pattern is selected automatically or manually, the control signals may or may not be transmitted to the electric devices to operate them in compliance with the selected device operation pattern. That is, the selected device operation pattern may be used as a so-called non-binding target. In this case, electricity charges may be lowered if the consumer uses the electric devices in conformity with the device operation pattern; electricity charges may be raised if the consumer does not obey the device operation pattern.

The device operation request group data T20 is usually set by the consumer. Alternatively, someone other than the consumer may establish the device operation request group data T20.

With the embodiment configured as described above, the operation pattern for the consumer's electric devices may be adjusted beforehand so that the devices may be operated as much as possible during the hours desired by the consumer when there are limits to the electric power usable by the consumer. Thus in the case where there are constraints on the supply of electric power, the electric power may be used as desired by the consumer so as to enhance the consumer's convenience.

The case in which the electric power usable by the consumer is limited is, for example, when the output of electric power generated in-house by the consumer's PV is used as a power source in self-sufficient fashion, or when the power system is arranged to limit the electric power usable by the consumer.

This embodiment is effective even when there are no constraints on usable electric power. For example, if the consumer desires to minimize electric power from the power system, the consumer's desire may be met by use of the electric devices in keeping with the device operation pattern.

### First Embodiment

FIG. 2 shows a typical overall configuration of a power system including a consumer energy management system 200 as the first embodiment of this invention.

The power system is a system that supplies electric power to each consumer. For example, the power system may be configured with a power plant 5, a transmission network 6, a distribution network 7, and facilities such as substations and switches.

In addition to ordinary households 20, the consumers include relatively large-scale consumers such as building 20A, factory 20B, supermarket 20C, and school 20D. The consumer as the ordinary household 20 is furnished with various electric devices 21 through 27. FIG. 2 shows a photovoltaic facility (PV) 21, a storage battery 22, an electric water heater 23, an air-conditioner 24, a television set (called TV hereunder) 25, a refrigerator 26, and a washing machine 27 as typical electric devices. There may also be provided such electric devices as a drying machine, a lighting system, a personal computer, audio equipment, and an electric vehicle (EV).

As with the stationary storage battery for use in the household, the storage battery mounted on the electric vehicle stores and discharges electric power. In the ensuing description, these devices installed at the consumer's end may be generically called consumer devices. The devices 23 through 27 among these consumer devices may further be called electric loads.

DSM (Demand Side Management) 10 is connected communicably to the energy management system 200 of each consumer. The DSM 10 manages demand for electricity in a prescribed area. From the consumer energy management system 200, the DSM 10 collects information such as the amount of electric power consumed and generated by the consumer. The DSM 10 transmits target values to the consumer energy management system 200 for demand regulation.

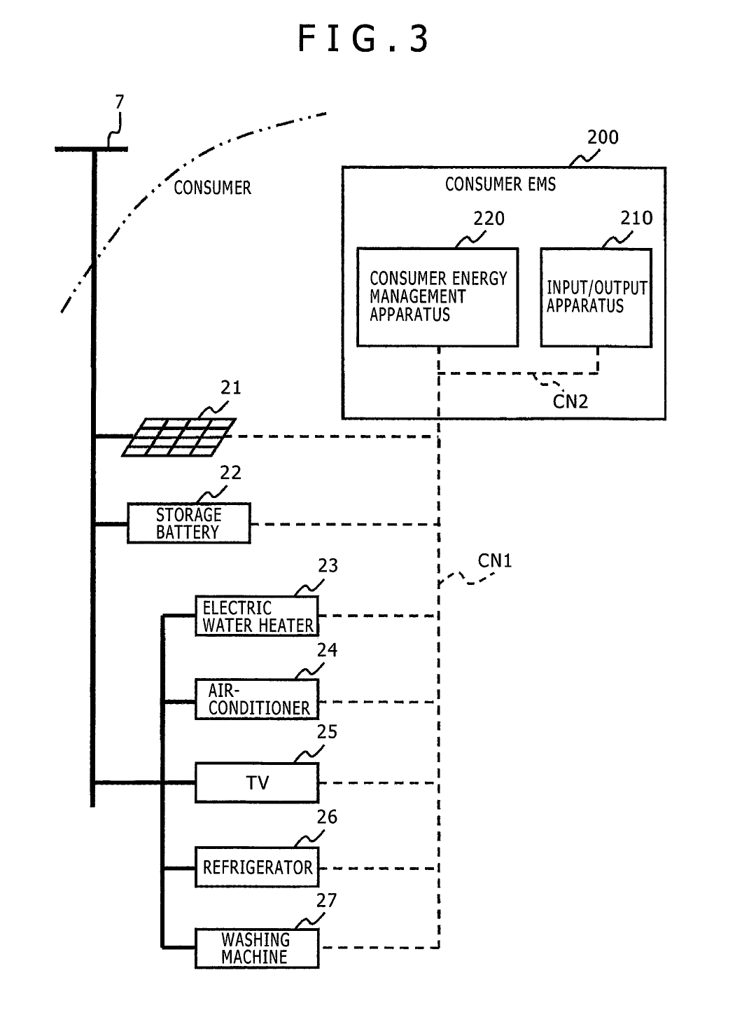

FIG. 3 shows a typical configuration of the devices making up the consumer energy management system (called consumer EMS hereunder) 200. The consumer EMS 200 includes an input/output apparatus 210 and a consumer energy management apparatus 220. The apparatuses 210 and 220 are connected with each other in bidirectionally communicable fashion via a communication network CN2.

The input/output apparatus 210 receives information from the user acting as the administrator of the consumer EMS 200 (the administrator is called user or the consumer hereunder) or offers information to the user. The input/output apparatus is composed of an input apparatus and an output apparatus. The input apparatus may be a keyboard switch, a pointing device such as a mouse, or a voice command device, for example. The output apparatus may be a display device, a printer, or a voice synthesizer, for example.

The input/output apparatus 210 may be configured as an information terminal that manages electric power and may be installed in the kitchen or in the living room of the consumer 20. Alternatively, the input/output apparatus 210 may be integrated into an existing electric device such as the TV. As another alternative, a mobile phone, a portable information terminal, or a personal computer may be utilized as the input/output apparatus 210.

The EMS apparatus 220 is connected to each of the consumer devices 21 through 27 in a bidirectionally communicable fashion via a communication network CN1. The management apparatus 220 will be discussed later in detail.

The consumer EMS 200 is a system that adjusts the operating status of the consumer devices. If links between the consumer and the power system have been severed due to an accident in the transmission or distribution system, for example, the consumer EMS 200 adjusts the operating status of the electric loads by maintaining the demand-and-supply balance of the electric power (W) consumed in-house by the consumer as well as the supply-demand balance of the electric energy (Wh) consumed per unit time.

That is, once the linkage between the power system and the consumer has been cut off, the consumer EMS 200 maintains the total supply-demand balance of the electric power (W) generated by the PV 20, the electric power (W) discharged by the storage battery 22, and the electric power (W) consumed by the electric loads 23 through 27. Further, the consumer EMS 200 maintains the total supply-demand balance of the electric energy (Wh) generated by the PV 21, the electric energy (Wh) discharged by the storage battery 22, and the electric energy (Wh) consumed by the electric loads 23 through 27 per unit time. While maintaining such supply-demand balance, the consumer EMS 200 adjusts the operating status of the consumer's electric loads 23 through 27 in such a manner as to meet the consumer's needs for power use as much as possible, i.e., to maximize the consumer's convenience or comfort.

The PV 21 generates electric power in accordance with the weather or other conditions, leaving things to chance. The electric power generated by the PV 21 can be consumed by the electric loads 23 through 27, stored into the storage battery 22, or sent to the power system. The storage battery 22 stores the electric power from the PV 21 or from the power system. The storage battery 22 discharges electric power to compensate for an insufficient amount of electric power generated solely by the PV 21 and consumed by the electric loads 27 through 27. Charging to and discharging from the storage battery 22 is subject to the state of charge (SOC) of the battery and to battery performance constraints.

For example, consider a case in which only a small amount of electric power is generated by the PV 21 because of bad weather, with a limited amount of electric power discharged by the storage battery 22. In such a case where the electric power discharged by the storage battery 22 and the electric power generated by the PV 21 fail to provide all electric power to be consumed by the electric loads 23 through 27, at least some of the electric loads 23 through 27 become inoperable and are be stopped.

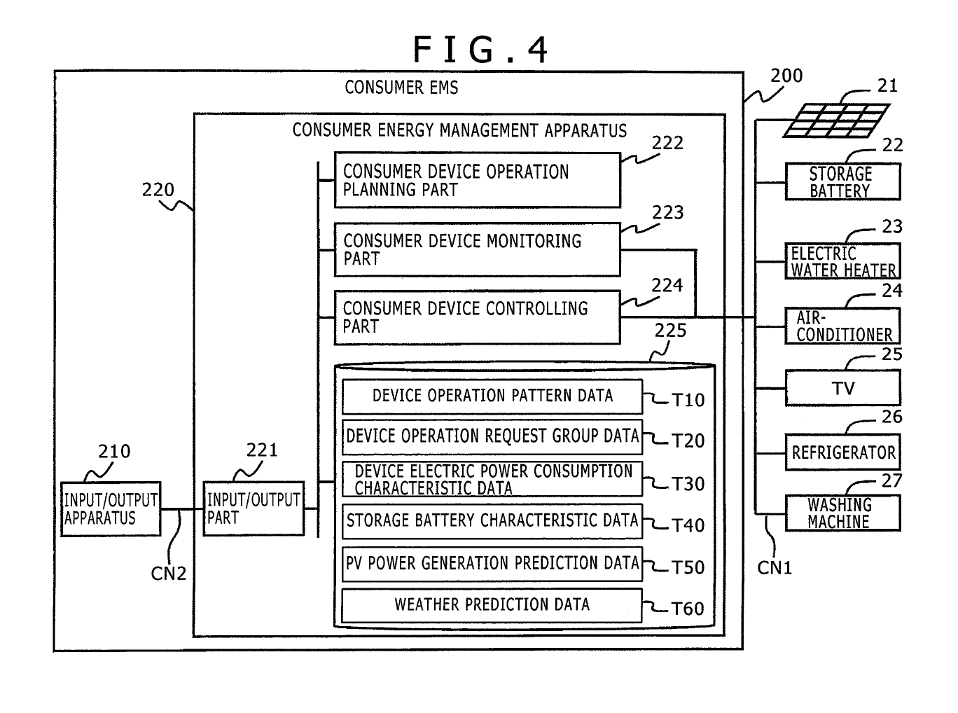

FIG. 4 is a functional block diagram showing a typical configuration of the consumer energy management apparatus (called a management apparatus hereunder) 220.

The management apparatus 220 is configured to include an input/output part 221, the consumer device operation planning part 222, the consumer device monitoring part 223, the consumer device controlling part 224, and a data management part 225, for example.

The input/output part 221 is connected to the input/output apparatus 210. The input/output part 211 creates an input screen that allows the user to input various data to the management apparatus 220, the input/output part causing the input/output apparatus 210 to display the input screen.

The user inputs various data (information) via the input/output apparatus 210 which forwards the input data to the data management part 225 where the input data will be managed. The input data may include, for example, device operation request group data T20 falling within the consumer's control target period, device electric power consumption characteristic data T30, storage battery characteristic data T40, PV power generation prediction data T50, and weather prediction data T60.

Further, the input/output part 221 can acquire consumer device operation pattern data (called device operation pattern data hereunder) T10 within the control target period from the data management part 225 and output the data T10 to the input/output apparatus 210 for display.

The data management part 225 is a function that stores and manages data. The data management part 225 manages various data using of a storage device such as a flash memory device or a hard disk drive.

The data management part 225 acquires, for example, the device operation pattern data T10, device operation request group data T20, device electric power consumption characteristic data T30, storage battery characteristic data T40, PV power generation prediction data T50, and weather prediction data T60 from other functional blocks, and stores the acquired data. Also, in response to a reference request from another function block, the data management part 225 extracts the applicable data and outputs the extracted data to the requesting functional block.

The user may arrange to input the device electric power consumption characteristic data T30, storage battery characteristic data T40, PV power generation prediction data T50, and weather prediction data T60 to the management apparatus 220. Alternatively, the management apparatus 220 may acquire these items of data from external devices via a communication network.

The device operation pattern data T10 will be discussed later. The device operation request group data T20 will also be described in subsequent paragraphs.

The device electric power consumption characteristic data T30 is data about the characteristics of electric power consumption by the consumer's electric loads 23 through 27. For example, the device electric power consumption characteristic data T30 is used to manage the values of electric power consumed immediately after startup and in normal operating status as the characteristics of the electric power (W) consumed in normal operating status and of the electric energy (Wh) consumed per unit time (e.g., thirty minutes; the same applies hereunder). Further, the device electric power consumption characteristic data T30 is used to manage the electric power characteristics in effect when the operating status is changed by externally issued instructions as well as the electric power characteristics that vary with fluctuations in environmental conditions such as external temperature.

The storage battery characteristic data T40 is data for managing the characteristics of the storage battery 22. The characteristics of the storage battery 22 include, for example, a minimum state of charge, a maximum state of charge, maximum charging power, maximum discharging power, maximum charging energy per unit time, and maximum discharging energy per unit time.

The PV power generation prediction data T50 is data for predicting the electric power to be generated by the PV 21. The PV power generation prediction data T50 is used to manage the predicted values of the electric power (W) to be generated by PV at each control time within the control target period, as well as the predicted values of the electric energy (Wh) generated by PV per unit time.

The weather prediction data T60 is data for indicating predicted weather condition. The weather prediction data T60 may be acquired from a weather information server (not shown) offering weather information service, for example. The weather prediction data T60 includes predicted values of the weather condition such as temperature and humidity at each control time within the control target period.

The consumer device monitoring part 223 acquires and manages the data on the operating status of the consumer devices 21 through 27. The operating status data varies depending on the type or nature of the consumer device. The operating status data may include current values of operation mode status and of various settings, for example.

The operating status data on the PV 21 includes generated electric power (W), electric energy (Wh) generated per predetermined unit time, and solar irradiance.

The operating status data on the storage battery 22 includes the electric power (W) discharged by the storage battery, electric energy (Wh) discharged per predetermined unit time, and the state of charge (Wh), for example.

The operating status data on the electric water heater 23 includes start-and-stop status of heat storage operations, current values of the amount of consumed electric power and of the remaining amount of stored heat in a hot water storage tank, and settings of boiling temperature, for example.

The operating status data on the air-conditioner 24 includes start-and-stop status, the operating state such as whether the operation is in cooling or heating, consumed electric power (W), electric energy (Wh) consumed per predetermined unit time, temperature setting, air volume setting, and wind direction setting, for example.

The operating status data on the TV 25 includes start-and-stop status, consumed electric power (W), and electric energy (Wh) consumed per predetermined unit time, for example.

The operating status data on the refrigerator 26 includes start-and-stop status, cooling operation start-and-stop status, consumed electric power (W), electric energy (Wh) consumed per predetermined unit time, and cooling intensity settings, for example.

The operating status data on the washing machine 27 includes start-and-stop status, consumed electric power (W), electric energy (Wh) consumed per predetermined unit time, the remaining time till washing completes, and washing or rinsing count settings, for example.

Although not shown, the operating status data on the drying machine includes start-and-stop status, consumed electric power (W), electric energy (Wh) consumed per predetermined unit time, the remaining time till drying completes, and drying mode setting, for example. The content of the operating status data is further determined in accordance with the nature of other consumer devices than those described above.

The predetermined unit time may be one minute, thirty minutes, one hour, or two hours, for example. The predetermined unit time is assumed to be thirty minutes in the ensuing explanation.

The consumer device controlling part 224 outputs control signals to the consumer devices to change their operating status in such a manner that the device operation pattern data (also called device operation pattern hereunder) T10 stored in the data management part 225 will be implemented. In the device operation pattern T10, as will be discussed later, the operating status of each consumer device are set with regard to each time of day in a predetermined control target period (called control time hereunder). The consumer device controlling part 224 outputs the control signals to the consumer devices such that their operating status at each control time will meet the settings in the device operation pattern T10. The device operation pattern T10 can be revised at each control time. That is, the device operation pattern T10 may be updated repeatedly in keeping with latest condition.

The control target period can be the period ranging from the current time of day to the end of that day (up to 24:00), the period of the entire next day, or a one-week period starting from the next day, for example. For purpose of simplification and illustration, the control target period is hereunder assumed to be the period of the entire next day.

The interval for prescribing the control time may presumably be thirty minutes, one hour, or two hours, for example. For purpose of simplification and illustration, a thirty-minute interval is hereunder assumed for control purposes. The interval at which to collect the operating status data from the consumer devices (e.g., thirty-minute interval) may or may not be the same as the interval at which to output the control signals to the consumer devices (e.g., thirty-minute interval).

The operation planning part 222 creates the device operation pattern T10 within a given control target period and stores the created pattern into the data management part 225. The device operation pattern T10 is created in such a manner as to have high goodness of fit with the device operation request group data T20 insofar as predetermined constraints are met.

The predetermined constraints are such as to require that the electric power generated in-house by the PV 21 of the consumer and the electric power discharged by the storage battery 22 be sufficient for the devices to operate. That is, the constraints are those requiring that the consumer devices be operated within the supply of electric power available to the consumer.

The operation planning part 222 creates the device operation pattern T10 such as to operate maximally the consumer devices requested by the device operation request group data T20 insofar as the predetermined constraints are met. As described above, the device operation pattern T10 can be updated at intervals of the control time.

The device operation pattern T10 created by the operation planning part 222 is not limited to be one that can maximally implement the device operation request group data T20 under predetermined constraints. As will be discussed later in conjunction with other embodiments, the user may be presented with a plurality of device operation pattern candidates having different ‘goodness of fit’ indicating the degree of satisfying the device operation request group data T20, and the user may select one of the pattern candidates. The device operation pattern T10 selected by the user does not always have the highest goodness of fit.

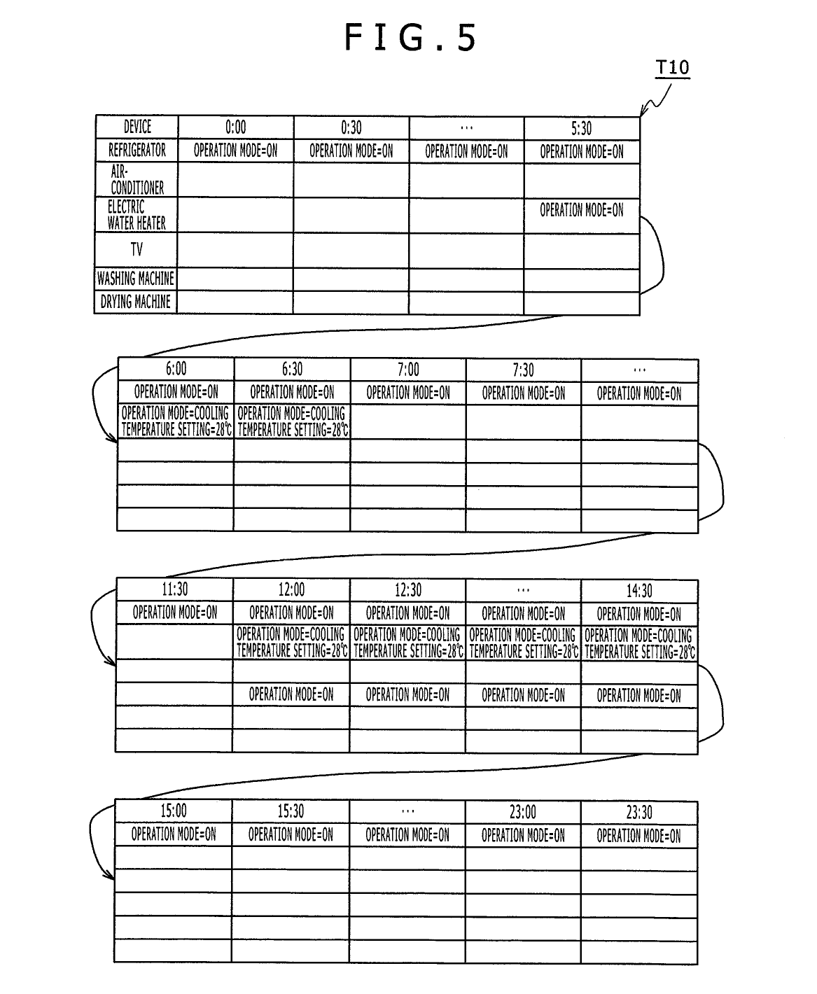

FIG. 5 shows an example of the device operation pattern T10. The device operation pattern T10 can be defined, for example, as the data for changing the operating status of the consumer devices at each control time within the control target period.

The changes in the operating status such as operation mode changeover and changed settings, are those that can be manipulated from outside the consumer devices.

In the case of the PV 21, power-on, power-off, power generation stop, power generation start, etc., can be changed. With the storage battery 22, it is possible to change power-on, power-off, specified electric power (W), charging and discharging of electric energy (Wh) at predetermined unit time, etc. With the electric water heater 23, power-on, power-off, start and stop of heat storage operations, and other settings can be changed. With the air-conditioner 24, it is possible to change power-on, power-off, operation mode switchover, and other settings. With the TV 25, power-on and power-off can be changed. With the refrigerator 26, power-on, power-off, and other settings can be changed. With the washing machine 27, it is possible to change power-on, power-off, etc. With the draying machine, power-on, power-off, and other settings can be changed.

As shown in FIG. 5, the device operation pattern T10 holds the settings for changing the operating status of each consumer device at every control time (at time every thirty minute) in each control period (from 0:00 to 23:30 of the next day in the example of FIG. 5). Settings may be added to change the operating status of the PV 21 and storage battery 22 which are not shown in FIG. 5.

Blank columns with no settings inside indicate that the customer devices corresponding to these columns are not subject to control (i.e., not to be operated). If attention is drawn to the operating status of the refrigerator shown in FIG. 5, the refrigerator 26 is found starting to operate at 0:00 and continuing to operate until 23:30. That is, according to the operation plan (device operation pattern) of the next day, the refrigerator 26 operates the whole day.

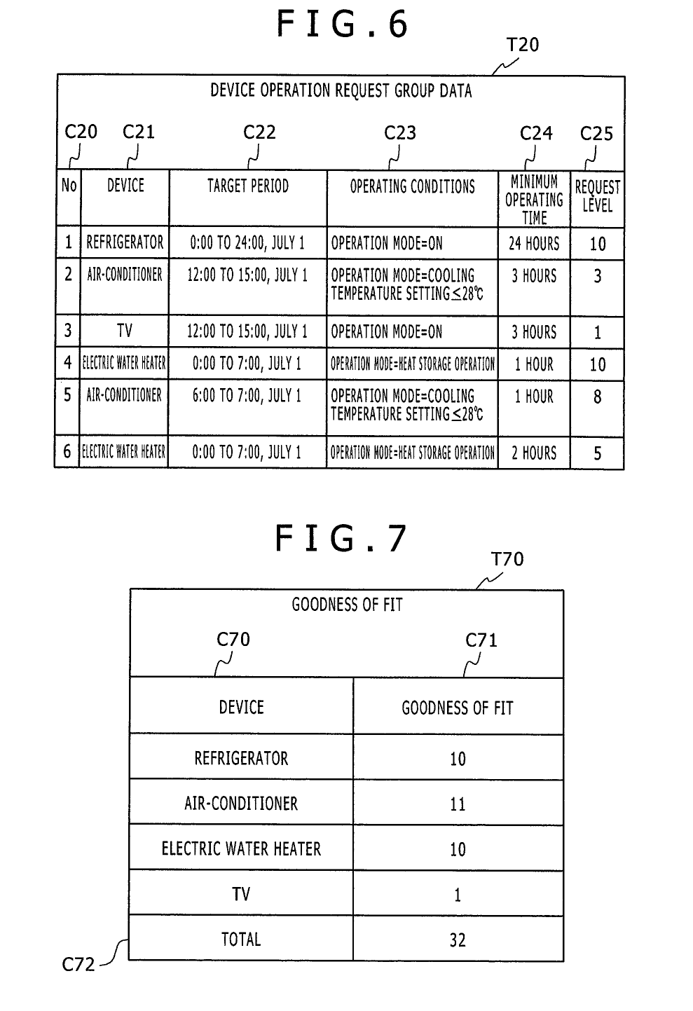

FIG. 6 shows an example of the device operation request group data T20. The device operation request group data T20 is data for managing the consumer's needs for operating the devices. The goodness of fit with the device operation request group data T20 are numerical indicators indicating how much the content of the device operation request group data T20 is met by the content of the device operation pattern T10.

The device operation request group data T20 is a bundle of individual device operation request data regarding a plurality of consumer devices. For example, as shown in FIG. 6, the device operation request group data T20 is managed with request numbers C20, consumer device identifiers C21, target periods C22, operating conditions C23, minimum operating times C24, and request levels C25 in association with one another.

The request numbers C20 are information for distinguishing the device operation request data regarding the individual consumer devices. Serial numbers are set in the request numbers C20, for example. The consumer device identifiers C21 are set with information for identifying the target consumer devices. In FIG. 6, the names of the customer devices are given for the sake of ease of understanding. Alternatively, the item C21 may be set with values of numbers, alphabetical characters, or their combination for identifying the consumer devices. In the ensuing explanation with reference to FIG. 6, the consumer device identified by the item C21 is called a target device.

The target periods C22 each represent the period for controlling the operating status of the corresponding target device. A desired time slot within the control target period can be set as the target period. Since the target control period is the entire next day for this embodiment, any time slot from 0:00 to 23:30 may be specified as the target period C22 for the target device of interest.

The operating conditions C23 represent those for the target devices (e.g., operation mode, settings). As explained above, the consumer device controlling part 224 can externally change the operating conditions. This category of data is data for setting one or more of the operating conditions for the target devices.

The minimum operating times C24 each represent the hours in which the corresponding target device is desired to be operated minimally within the target period C22. The minimum operating times C24 may coincide with the target periods C22 or may be shorter than the latter. If the minimum operating time C24 is shorter than the corresponding target period C22, that means the target device is to be operated only during the minimum operating time C24 in any time slot within the target period C22. For example, when attention is drawn to the electric water heater 23 at No. 4, the target period C22 of the electric water heater 23 is found to be ranging from 0:00 to 17:00. The minimum operating time C24 of the electric water heater 23 is one hour. Thus the device operation request data for No. 6 is met if the electric water heater 23 can be operated only one hour sometime between 0:00 to 17:00.

The request levels C25 constitute information indicative of the levels of the user's (consumer's) desires. For example, within a predetermined range, the consumer can set desired values to the request levels C25.

FIG. 6 shows an example in which the request levels C25 are each set within the range of 1 to 10. The range in which the request levels can be set is not limited to the range of 1 to 10; the range may be from 1 to 100, 1 to 1000, or any other diverse options. Also, the request levels may each be set with the use of symbols or alphabetic characters such as A, B, and C (e.g., A>B>C as request levels) instead of the numerical designations.

Furthermore, the consumer may be allotted predetermined points, and may set the request levels C25 within the range of these points. For example, given “100” points, the consumer may set to each of the target devices a request level that falls within the range of the allotted points. This arrangement will be all the more effective where a plurality of consumers are grouped for management purposes, as will be discussed later. The allotted points may be a fixed value determined beforehand by the consumer EMS 200 or may be a value varying with appropriate indicators. For example, the consumer's contribution to the power system may be measured, and the points allotted to the consumer may be changed in accordance with the measured degree of contribution.

A specific explanation of this aspect is given below with reference to FIG. 6. The device operation request at No. 1 means that “the refrigerator 26 is be operated for 24 hours between 0:00 and 24:00 on July 1” and that “the request level for this operation is 10.” That is, the consumer strongly requests that the refrigerator 26 be operating non-stop.

The device operation request at No. 2 means that “the air-conditioner 24 is to be operated for at least three hours in cooling mode at the temperature setting of 28 degree Celsius or lower between 12:00 and 15:00 on July 1” and that “the request level for this operation is 3.”

The device operation request at No. 3 means that “the TV 25 is to be operated for at least three hours between 12:00 and 15:00 on July 1” and that “the request level for this operation is 1.” The consumer's desire to operate the TV 25 is found out not to be strong.

The combination of the device operation request at No. 2 with the device operation request at No. 3 can express, in relatively a simple way, a complicated device operation request to “operate the TV 25 and the air-conditioner 24 both if possible, or only the air-conditioner 24 preferentially if both cannot be operated simultaneously, between 12:00 and 15:00 on July 1.”

The device operation request at No. 4 means that “the electric water heater 23 is to be operated for at least one hour in heat storage operation mode between 0:00 and 7:00 on July 1” and that “the request level for this operation is 10.” The consumer's request level for the operation of the electric water heater 23 is 10, the same as for the refrigerator 26. The consumer can issue, in relatively simple fashion, the device operation request that “the electric water heater 23 need only be operated for one hour between 0:00 and 7:00 on July 1.”

The device operation request at No. 5 means that “the air-conditioner 24 is to be operated for at least one hour in cooling mode at the temperature setting of 28 degree Celsius or lower between 6:00 and 7:00 on July 1” and that “the request level for this operation is 8.”

Thus the combination of the device operation request at No. 4 with the device operation request at No. 5 can express a complicated device operation request that “if the electric water heater 23 can be operated in heat storage operation for at least one hour between 0:00 and 6:00, then the air-conditioner 24 should preferably be operated preferentially between 6:00 and 7:00.”

The device operation request at No. 6 means that “the electric water heater 23 is to be operated for at least two hours in heat storage operation mode between 0:00 and 7:00 on July 1” and that “the request level for this operation is 5.”

The combination of the device operation request at No. 4 with the device operation request at No. 6 can express the device operation request that “the electric water heater 23 be operated for one hour at the request level 10 and for another two hours at the request level 5.” That is, the combination can simply express a relatively complicated device operation request that “the electric water heater 23 should preferably be operated for one hour and, if there is still remaining power for the heater to run, for another two hours.”

There exist numerous kinds of the consumer devices 21 through 27, and the consumer has diverse desires to operate these devices. It is difficult for the consumer accurately to consider the supply-and-demand balance of electric power in individually operating the consumer devices. It is also difficult effectively to utilize the supply of electric power from the PV 21 and from the storage battery 22. By contrast, this embodiment allows the consumer to create the device operation request data on each of the consumer devices in a relatively simple manner without regard to the supply-demand balance of electric power at each control time.

The device operation request data on each of the consumer devices is created on the basis of the consumer's vague desire. These device operation request data are managed in a unified fashion as the device operation request group data T20.

The management apparatus 220 creates a plurality of device operation patterns serving as combinations of the operating status of the consumer devices, and selects as the device operation pattern T20 one of the candidates that meets the device operation request group data T20 as much as possible. What follows is an explanation of the goodness of fit as indicators of how much the device operation pattern candidates satisfy the device operation request group data T20.

FIG. 7 shows a typical fit degree table T70 that stores the goodness of fit (conformance) of a given device operation pattern T10 with the device operation request group data T20 indicated in FIG. 6.

The fit degree table T70 includes information C70 for identifying the consumer devices, individual goodness of fit C71 calculated with regard to each of the consumer devices, and a total goodness of fit C72 as the sum of the individual goodness of fit C71.

The goodness of fit C71 of each consumer device applies when the device operation request data on the consumer device in question is met by the device operation pattern T10. If there exist a plurality of device operation request data on the same consumer device, the sum of the goodness of fit of all device operation request data meeting the device operation pattern T10 becomes the goodness of fit C71 of the individual consumer device in question. The total goodness of fit C72 is the sum of the goodness of fit of the individual devices.

More specifically, the device operation pattern T10 shown in FIG. 5, for example, involves having the refrigerator 26 operated continuously for 24 hours between 0:00 and 24:00 on July 1. Thus the device operation pattern T10 in FIG. 5 meets the device operation request data at No. 1 in FIG. 6. As a result, the value of the request level C25 of the device operation request data on the refrigerator 26 is stored as the goodness of fit C71 of the refrigerator 26.

The device operation pattern T10 in FIG. 5 further involves having the air-conditioner 24 operated in cooling mode at the temperature setting of 28 degree Celsius or lower, for one hour between 6:00 and 7:00 and for another three hours between 12:00 and 15:00 on July 1. Thus the device operation pattern in FIG. 5 meets the device operation request data at No. 2 and at No. 5 in FIG. 6. As a result, “11”, which is the sum of the request level “3” of the device operation request data at No. 2 and the request level “8” of the device operation request data at No. 5, is stored in the goodness of fit C71 of the air-conditioner 24.

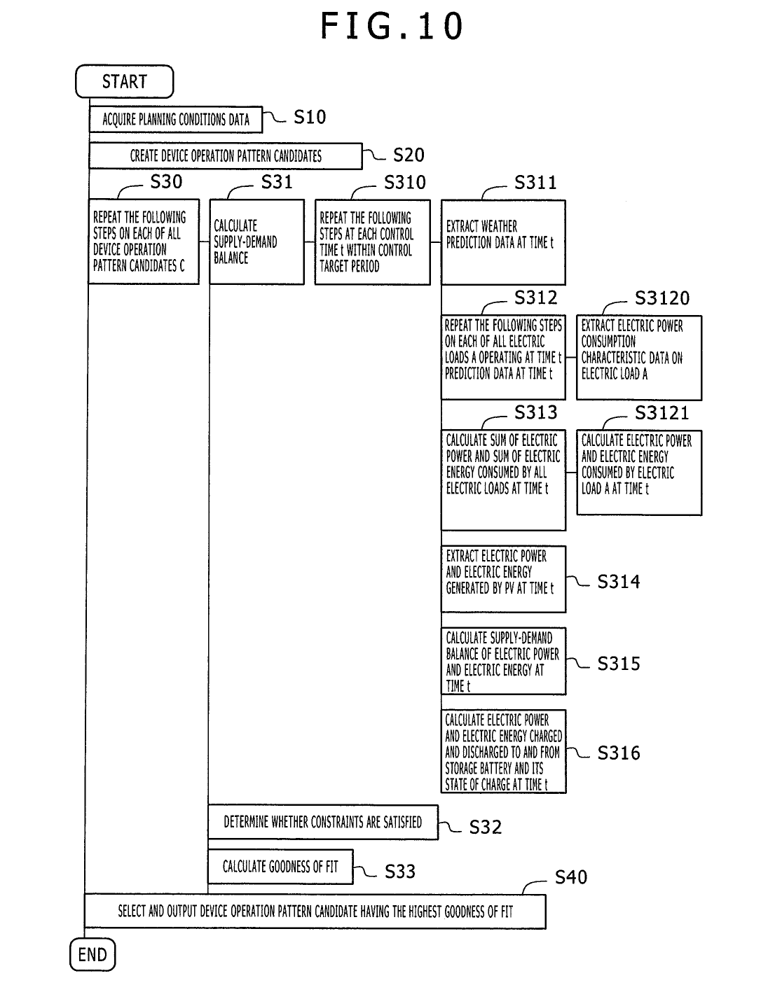

Furthermore, the device operation pattern T10 in FIG. 10 assumes that the electric water heater 23 will be operated for 1.5 hours between 0:00 and 7:00 on July 1. In this case, the device operation pattern meets the device operation request data on the electric water heater 23. Thus, the request level “10” of the device operation request data at No. 4 is stored in the goodness of fit C71 of the electric water heater 23.

The device operation pattern T10 in FIG. 5 involves having the TV 25 operated for three hours between 12:00 and 15:00 on July 1. Thus the pattern meets the device operation request data (at No. 3 in FIG. 6) on the TV 25. As a result, the request level “1” of the device operation request data at No. 3 is stored in the goodness of fit C71 of the TV 25.

In this manner, the goodness of fit with regard to the consumer devices are calculated and stored in the fit degree table T70 in FIG. 7. In the case of the above example, the total goodness of fit is “32.”

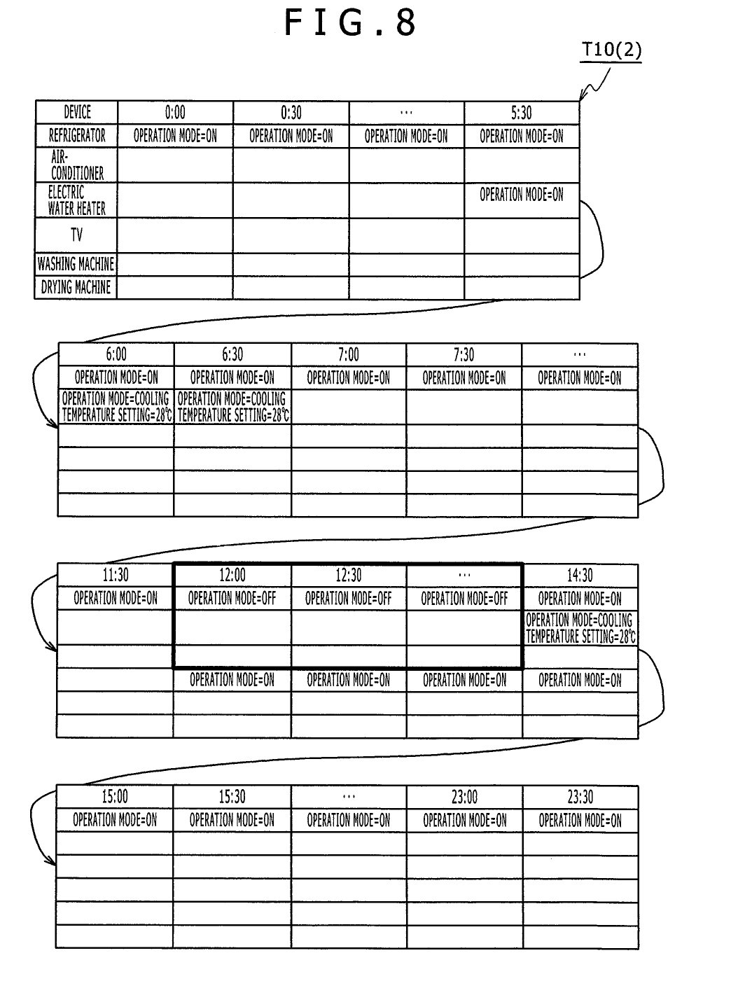

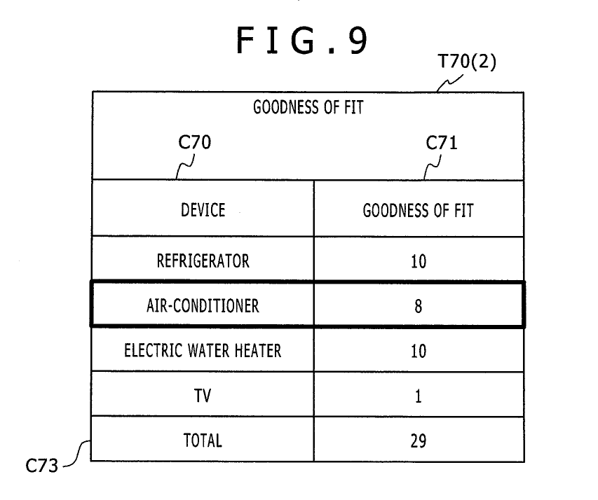

Explained below with reference FIGS. 8 and 9 are the results of calculation of the goodness of fit in the case of a different device operation pattern T10(2). The device operation pattern T10(2) shown in FIG. 8 differs from the device operation pattern T10 discussed above in relation to FIG. 5 in that, as indicated by a thick black frame in FIG. 8, the air-conditioner 24 stops for three hours between 12:00 and 15:00.

FIG. 9 shows a fit degree table T70(2) indicating the goodness of fit of the device operation pattern T10(2) in FIG. 8 with the device operation request group data T20 in FIG. 6. The device operation pattern T10(2) in FIG. 9 does not meet the device operation request data at No. 2 regarding the air-conditioner 24. With regard to the air-conditioner 24, the device operation pattern T10(2) in FIG. 9 meets only the device operation request data at No. 5. Thus, the request level “8” of the device operation request data at No is stored in the goodness of fit C71 of the air-conditioner 24. As a result, the total goodness of fit C72 becomes “29.”

In this manner, if the device operation pattern T10 applied to the device operation request group data T20 is different, then the values in the fit degree table T70 also become different. The device operation pattern T10 having the highest total goodness of fit C72 may presumably best conform to the consumer's intent (device operation request group data T20).

FIG. 10 shows the process performed by the operation planning part 222 to create the device operation pattern T10. In the ensuing description, steps may each be abbreviated as “S.”

(S10) Acquisition of Planning Conditions Data

The operation planning part 222 acquires from the data management part 225 planning conditions data within the control target period, the data being needed for creating the device operation pattern T10. For example, the planning conditions data includes the PV power generation prediction data T50, weather prediction data T60, device operation request group data T20, device electric power consumption characteristic data T30, and storage battery characteristic data T40.

(S20) Creation of Device Operation Pattern Candidates

The operation planning part 222 creates a large number of device operation pattern candidates by randomly setting the changed content of the operating status at each control time for the respective consumer devices. The device operation pattern candidates may be created to cover all combinations of the changed content of the operating status at each control time; the candidates may be created to cover the combinations within a predetermined range; or a predetermined number of device operation pattern candidates may be created randomly as in this embodiment. In the ensuing description, the device operation pattern candidates may simply be referred to as the candidates.

(S30) Steps (S31) through (S33) below are repeated on each of a plurality of device operation pattern candidates.

(S31) Calculation of Supply-Demand Balance for a Candidate

The operation planning part 222 repeats steps (S310) and (S311) through (S316) at each control time “t” within the control target period.

The operation planning part 222 prepares a supply-demand balance achievement flag as flag data in which the result of determination on whether supply-demand balance is established for the candidate is stored. The operation planning part 222 sets an initial value “1” to the supply-demand balance achievement flag. The supply-demand balance achievement flag is the data indicating whether the supply of electric power available to the consumer exceeds the electric power consumed by the consumer. When the supply-demand balance is achieved, “0” is set; when the supply-demand balance is not achieved, “1” is set.

(S311) Extraction of Weather Prediction Data T60 at Time “t”

The operation planning part 222 extracts from the weather prediction data T60 the predicted values of the weather condition that can affect the electric power or the electric energy consumed by the electric loads. The predicted values of the weather condition may be the temperature and humidity at time “t” among others.

### (S312)

The operation planning part 222 repeats steps (S3120) and (S3121) on all electric loads operating at time “t.”

(S3120) Extraction of Electric Power Consumption Characteristic Data on the Electric Load

The operation planning part 222 extracts various characteristic data on the electric power and electric energy consumed by the electric load from the device electric power consumption characteristic data T30.

(S3121) Calculation of the Electric Power and Electric Energy Consumed by the Electric Load at Time “t”

When the electric load transitions from a stopped state to an activation state at time “t,” the operation planning part 222 sets as the consumed electric power and consumed electric energy the values which are needed immediately after startup and which correspond to the operating status to be changed by the candidate and to the weather condition at time “t.”

When the electric loads remains unchanged in the activation state at time “t,” the operation planning part 222 sets as the consumed electric power and consumed electric energy the values which are in normal operating status after startup and which correspond to the operating status to be changed by the candidate and to the weather condition at time “t.”

(S313) Calculation of the Sum of the Electric Power and that of the Electric Energy Consumed by all Electric Loads at Time “t”

The operation planning part 222 calculates the sum of the electric power consumed by all electric loads at time “t” and stores the result of the calculation as the total consumed electric power.

The operation planning part 222 calculates the sum of the electric energy consumed by all electric loads at time “t” and stores the result of the calculation as the total consumed electric energy.

(S314) Extraction of the Electric Power and Electric Energy Generated by the PV 21 at Time “t”

The operation planning part 222 extracts the electric power and electric energy generated at time “t” from the PV power generation prediction data T50.

(S315) Calculation of the Supply-Demand Balance of Electric Power and Electric Energy at Time “t”

The operation planning part 222 subtracts the total consumed electric power from the electric power generated by the PV 21 at time “t,” and stores the result of the subtraction as the supply-demand balanced electric power.

The operation planning part 222 subtracts the total consumed electric energy from the electric energy generated by the PV 21 at time “t,” and stores the result of the subtraction as supply-demand balanced electric energy.

(S316) Calculation of the Electric Power and Electric Energy Charged to and Discharged from the Storage Battery 22, as Well as its State of Charge at Time “t”

The operation planning part 222 sets the supply-demand balance achievement flag to “1” if the supply-demand balanced electric power is negative at time “t” and if the absolute value of the supply-demand balanced electric power is larger than the maximum discharging power. The operation planning part 222 determines that the supply-demand balance is not achieved.

The operation planning part 222 also sets the supply-demand balance achievement flag to “1” if the supply-demand balanced electric energy is negative at time “t” and if the absolute value of the supply-demand balanced electric energy is larger than the maximum discharging energy. This is because supply-demand balance is not achieved either in this case.

If the supply-demand balanced electric power at time “t” is positive, the operation planning part 222 selects the smaller of the supply-demand balanced electric power and the maximum charging power, gives a minus sign to the selected value, and sets the value as the charging/discharging power of the storage battery 22.

If the supply-demand balanced electric power at time “t” is negative, the operation planning part 222 selects the smaller of the supply-demand balanced electric power and the maximum discharging power, gives a plus sign to the selected value, and sets the value as the charging/discharging power of the storage battery 22. Accordingly, the value of the charging/discharging power of the storage battery 22 being positive means discharging of the battery; the value being negative means charging of the battery.

If the supply-demand balanced electric energy at time “t” is positive, the operation planning part 222 selects the smaller of the supply-demand balanced electric energy and the maximum charging energy, gives a minus sign to the selected value, and sets the value as the charging/discharging energy of the storage battery 22.

If the supply-demand balanced electric energy at time “t” is negative, the operation planning part 222 selects the smaller of the supply-demand balanced electric energy and the maximum discharging energy, gives a plus sign to the selected value, and sets the value as the charging/discharging energy of the storage battery 22. Accordingly, the value of the charging/discharging energy of the storage battery 22 being positive means that the storage battery 22 is in a discharging state over the entire unit time (e.g., thirty minutes); the value of the charging/discharging energy being negative means that the storage battery 22 is in a charging state over the entire unit time.

The operation planning part 222 adds the signed charging/discharging energy of the storage battery 22 at time “t” to the state of charge at time “t−1,” one unit time earlier than the target time “t,” and sets the result of the addition as the state of charge at time “t.” However, if the calculated state of charge falls short of the minimum state of charge of the storage battery 22, then the state of charge is updated with the minimum state of charge.

The operation planning part 222 updates the value of the charging/discharging energy of the storage battery 22 by subtracting from the charging/discharging energy of the storage battery 22 the difference between the minimum state of charge and the yet-to-be-updated state of charge falling short thereof (=minimum state of charge−yet-to-be-updated state of charge).

The operation planning part 222 updates the value of the state of charge with the maximum state of charge if the calculated state of charge at time “t” is higher than the maximum state of charge of the storage battery 22.

The operation planning part 222 updates the value of the charging/discharging energy of the storage battery 22 by subtracting from the charging/discharging energy of the storage battery 22 the difference between the maximum state of charge and the yet-to-be-updated state of charge exceeding that state (=yet-to-be-updated state of charge−maximum state of charge).

(S32) Determination on Whether the Candidate Satisfies the Constraints

If the supply-demand balance achievement flag is set to “0,” the operation planning part 222 determines that the device operation pattern candidate satisfies the constraints. If the supply-demand balance achievement flag is set to “1,” the operation planning part 222 determines that the candidate does not satisfy the constraints.

(S33) Calculation of the Goodness of Fit of the Candidate

The operation planning part 222 sets the goodness of fit of the candidate to “−1” if the candidate does not meet the constraints

If the candidate meets the constraints, the operation planning part 222 compares the candidate with the device operation request group data as mentioned above so as to calculate the goodness of fit C71 of the individual devices and the total goodness of fit C72, and stores the calculated goodness of fit.

(4) Selection and output of the device operation pattern permitting the highest goodness of fit

The operation planning part 222 compares the goodness of fit of all device operation pattern candidates, selects the candidate permitting the highest goodness of fit as the device operation pattern T10, and outputs the selected pattern.

The consumer EMS 200 of this embodiment combines the electric power generated by the PV 21 and the electric power discharged by the storage battery 22 for use as an in-house power source of the consumer. By managing the supply-demand balanced electric power, supply-demand balanced electric energy, and the state of charge of the storage battery 22 chronologically over the entire control target period, the consumer EMS 200 allows the consumer devices to operate in a manner meeting the consumer's intent as much as possible, as explained below.

The consumer EMS 200 has the storage battery 22 discharge power to cover the electric power necessary for operating the consumer devices if the output of the PV 21 drops temporarily.

During the hours of the day when the output of the PV 21 falls short of the electric power needed to operate the consumer devices, the consumer EMS 200 first causes the storage battery 22 to be charged with power for a given length of time. After a sufficient state of charge is obtained, the operation planning part 222 operates the consumer devices by use of the discharge of the storage battery 22.

If the electric power generated by the PV 21 is not sufficient to cover a large amount of electric power consumed by the consumer devices immediately after startup, the operation planning part 222 compensates for the insufficient electric power by use of the discharge of the storage battery 22 for a short length of time immediately following the startup.

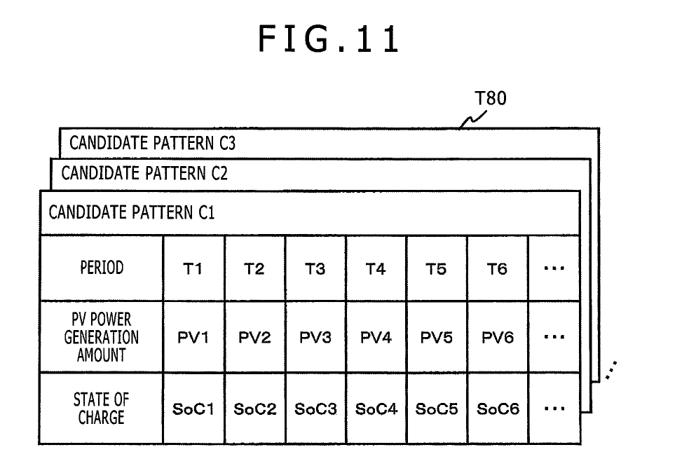

FIG. 11 shows a typical prediction table T80 in which the power generation amount of the PV 21 and the state of charge of the storage battery 22 are calculated at every a predetermined control time with regard to each of the device operation pattern candidates. In FIG. 11, the generated electric power and the generated electric energy are not distinguished from one another but are shown as the power generation amounts. The table T80 is created for each of the device operation pattern candidates. The operation planning part 222 may use the table T80 in step S314 of FIG. 10 or in other steps, for example.

The power generation amount of the PV 21 varies with the weather. Whether or not supply-demand balance is achieved depends on insolation. Thus even where the same device operation pattern candidate is combined with the same device operation request group data T20, if the weather worsens, supply-demand balance may not be achieved and a device operation pattern candidate may not be extracted.

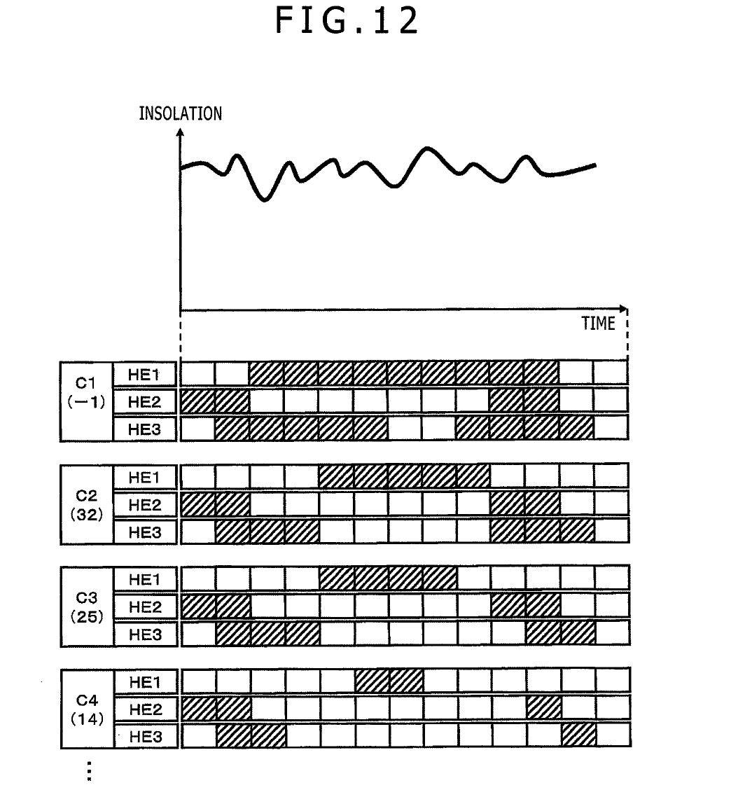

FIG. 12 shows device operation pattern candidates C1 through C4 and their goodness of fit when the weather is fine and insolation is high. In the figure, only three consumer devices HE1 through HE3 are shown. The hours of the day in which the consumer devices operate are shown shaded.

With regard to the candidate C1, the operating times of the consumer devices HE1 through HE3 are long, and a large amount of electric power is consumed, so that supply-demand balance is not achieved. Thus the goodness of fit of the candidate C1 is “−1.”

With regard to the other candidates C2 through C4, supply-demand balance is achieved. For example, the goodness of fit is “32” with the candidate C2, “25” with the candidate C3, and “14” with the candidate C4.

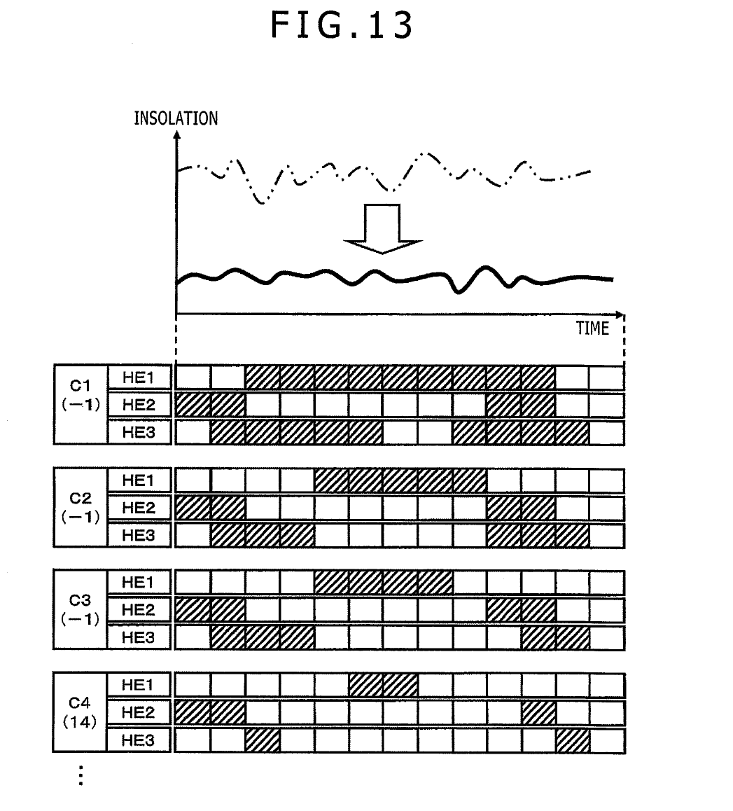

FIG. 13 shows the device operation pattern candidates C1 through C4 and their goodness of fit at a time of low insolation due to rainy weather or other factors. Compared with the insolation in fine weather indicated by two-dot chain line, the insolation in bad weather plotted by solid line is considerably low. As a result, the power generation amount of the PV 21 drops, and a sufficient amount of electric power cannot be stored into the storage battery 22.

Consequently, supply-demand balance is not achieved in bad weather not only with the candidate C1 but also with the candidates C2 and C3 with which supply-demand balance was achieved in fine weather. Only with regard to the candidate C4 in which the operating time of the consumer devices is the shortest, supply-demand balance is achieved.

According to this embodiment, even if the linkage between the consumer 20 and the power system has been severed due to a disaster or a breakdown, it is possible to operate the consumer devices (electric loads 23 through 27 in particular) in a manner meeting the consumer's intent by efficiently utilizing the power supplying capability possessed by the consumer.

According to this embodiment, the consumers (users) only need to describe their desires to operate the consumer devices in a given form. There is no need to consider complicated problems such as supply-demand balance. By simply describing the desires to operate the consumer devices, the consumers allow the devices to operate in the pattern best fit for their intent. The consumers' convenience is accordingly enhanced.

### Second Embodiment

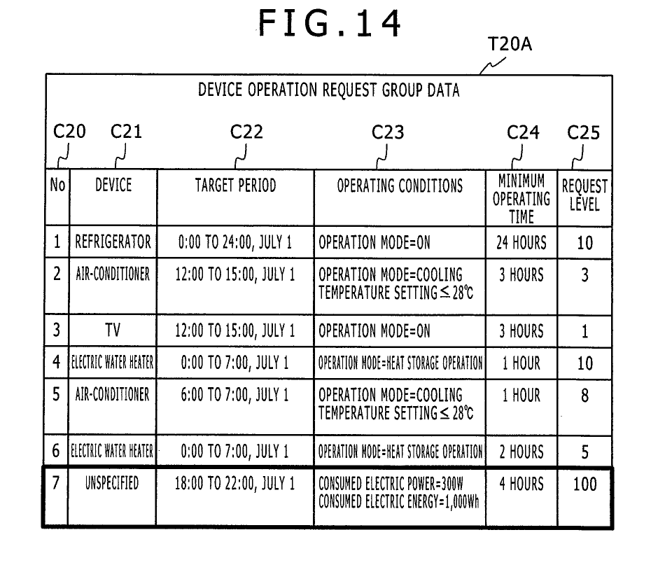

The second embodiment of the present invention is explained below with reference to FIG. 14. This and the subsequent embodiments of the present invention are variations of the first embodiment. Thus the ensuing explanation will focus on the differences from the first embodiment. The second embodiment is arranged to ensure an electric power quota not specified by purpose of use.

Compared with the first embodiment, the consumer EMS 200 of the second embodiment includes means for securing beforehand the electric power that can be used by the consumer for an unspecified purpose of use.

In this embodiment, the device operation request data meeting the conditions (1) through (3) below (the data is called device operation request data for an unspecified purpose of use hereunder) is added as the device operation request data that can be registered in the device operation request group data T20. If the electric power for the unspecified purpose is desired to be secured for a plurality of discontinuous time slots, the device operation request data corresponding to each of these time slots is to be registered.

(1) The value “unspecified” is set to the target consumer device C21.

(2) Both the value of consumed electric power (W) and that of consumed electric energy (Wh) are set to the target operation condition data C23. For example, if it is desired to secure the maximum electric power of 300 W and the electric energy of 1000 Wh per unit time (e.g., thirty minutes), the operating conditions C23 is set with “consumed electric power=300 W, consumed electric energy=1000 Wh.”

(3) The entire time period set to the target period C22 is established as the minimum operating time C24.

(4) The consumer may set a desired value as the request level C25. If it is desired to give top priority to securing electric power for an unspecified purpose of use, the consumer may set a particularly large value as the request level.

A modification in the process performed by the operating planning part 222 to create the device operation pattern is explained below. The process of step (S315) discussed above in reference to FIG. 10 is changed to step (S315A) described below.

(S315A) Calculation of the Supply-Demand Balance of Electric Power and Electric Energy at Time “t”

The operation planning part 222 subtracts the total consumed electric power from the electric power generated by the PV 21 at time “t” and sets the result of the subtraction as the supply-demand balanced electric power.

The operation planning part 222 subtracts the total consumed electric energy from the electric energy generated by the PV 21 at time “t” and sets the result of the subtraction as the supply-demand balanced electric energy.

If the device operation request data with “unspecified” set for the target consumer device C21 is registered in the device operation request group data T20, the operation planning part 222 acquires the values of the consumed electric power and consumed electric energy by referencing the operating conditions C23 of the device operation request data in question.

The operation planning part 222 updates the above-mentioned supply-demand balanced electric power with the value obtained by subtracting just the value of the consumed electric power. The operation planning part 222 updates the supply-demand balanced electric energy with the value obtained by subtracting exactly the value of the consumed electric energy.

The second embodiment has the above-described modification added to the configuration of the first embodiment, so that the device operation request data for unspecified purpose of use may be registered in the device operation request group data T20. Thus the consumer, after securing the electric power usable for the unspecified purpose of use, can get the management apparatus 220 to create the operation pattern T10 for the consumer devices.

The second embodiment configured as explained above offers the same advantages as the first embodiment. Because the second embodiment secures in advance the electric power for the unspecified purpose of use, the consumer's convenience is further improved. For example, if the consumer intends to pursue something unspecified such as housework, clerical work, or hobby handiwork most probably during the specific hours of the day, the consumer can secure the electric power for an unspecified purpose of use through this embodiment.

### Third Embodiment

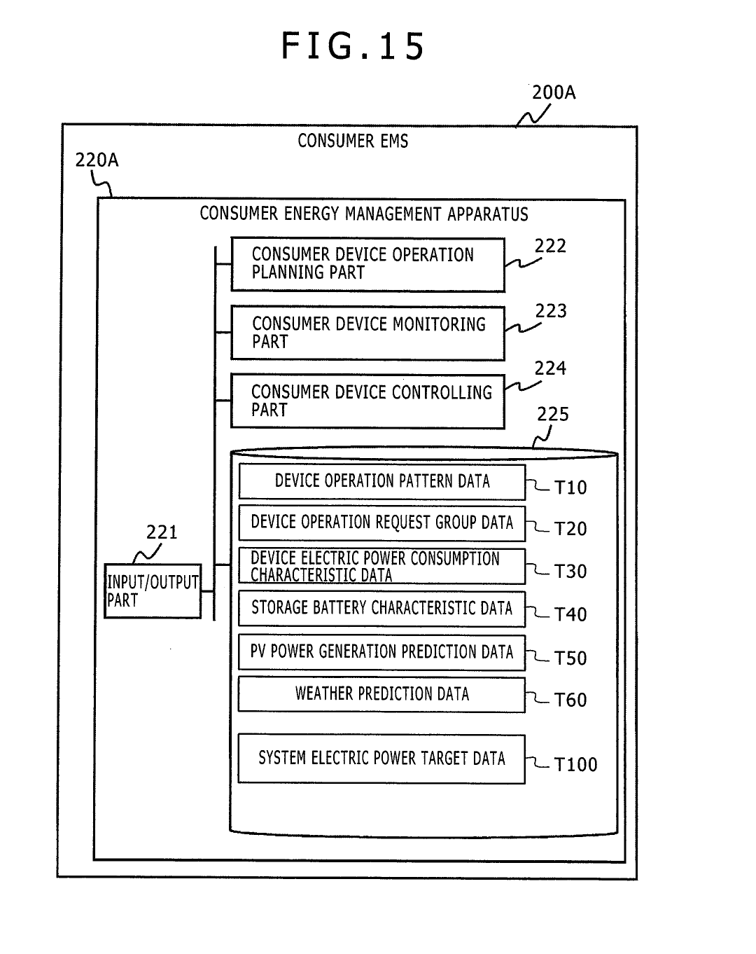

The third embodiment of the present invention is explained below with reference to FIG. 15. This embodiment deals with cases where the commercial electric energy purchased from the electric system is to be held below predetermined target values. That is, the third embodiment addresses the application of so-called demand response.

Where the consumer is linked to the electric system and supplied with electric power therefrom, the consumer EMS 200A of the third embodiment provides means for holding the electric power (W) from the electric system (called system electric power hereunder) and the electric energy (Wh) per unit time (called system electric energy hereunder) below predetermined targets.

The consumer EMS 200A of the third embodiment manages the target value of the system electric power (W) and that of the system electric energy (Wh) per unit time. The consumer EMS 200A maintains a total supply-demand balance of the consumed electric power (W) generated by the PV 21, the electric power (W) discharged by the storage battery 22, the electric power (W) consumed by the electric loads 23 through 27, and the system electric power (W). Further, the consumer EMS 200A maintains a total supply-demand balance of the electric energy (Wh) generated by the PV 21, the electric energy (Wh) discharged by the storage battery 22, the electric energy (Wh) consumed by the electric loads 23 through 27, and the system electric energy (Wh) per unit time.

In this manner, the consumer EMS 200A performs control to hold the system electric power (W) and system electric energy (Wh) below the target values while maintaining the supply-demand balance of the consumed electric power and consumed electric energy.

FIG. 15 shows a typical configuration of the consumer EMS 200A of the third embodiment. In dealing with the demand response application, the consumer EMS 200A of this embodiment differs partially from the consumer EMS 200 discussed in conjunction with the first and the second embodiments in the following points.

(First difference) From the input/output part 221 and input/output apparatus 210, the management apparatus 220 receives as user input the system electric power target data and system electric energy target data within the consumer's control target period (the data are abbreviated as the system electric power target data T100 in FIG. 15), and stores the receive data into the data management part 225. Also, as with the above-described embodiments, the management apparatus 220 acquires the device operation request group data T20, device electric power consumption characteristic data T30, storage battery characteristic data T40, PV power generation prediction data T50, and weather prediction data T60, and stores the acquire data into the data management part 225.

The input/output part 221 of the management apparatus 220 outputs an input screen for use by the user to the input/output apparatus 210 for screen display. Further, the input/output part 221 acquires the device operation pattern within the control target period from the data management part 225 and outputs the acquired pattern to the input/output apparatus 210 for display.

The system electric power target data T100 is the data providing the upper limit of the system electric power (W) at each control time within the control target period and the upper limit of the system electric energy (Wh) per unit time (e.g., thirty minutes).

(Second difference) The data management part 225 of the management apparatus 220 acquires and stores the system electric power target data T100. Also, as with the above-described embodiments, the data management part 225 acquires and stores the device operation request group data T20, device electric power consumption characteristic data T30, storage battery characteristic data T40, PV power generation prediction data T50, weather prediction data T60, and device operation pattern data T10.

(Third difference) The process of creating the device operation pattern is changed from step (S10) of the first and the second embodiments to step (S10A) below.

(S10A) Acquisition of Planning Conditions Data

From the data management part 225, the operation planning part 222 acquires the system electric power target data T100, PV power generation prediction data T50, weather prediction data T60, device operation request group data T20, device electric power consumption characteristic data T30, and storage battery characteristic data T40 within the control target period.

(Fourth difference) The process of creating the device operation pattern is changed from step (S315) to step (S315B) below.

(S315B) Calculation of the Supply-Demand Balance of Electric Power and Electric Energy at Time “t”

The operation planning part 222 subtracts the total consumed electric power from the sum of the system electric power upper limit and the PV-generated electric power at time “t,” and sets the result of the subtraction as the supply-demand balanced electric power.

The operation planning part 222 subtracts the total consumed electric energy from the sum of the system electric energy upper limit and the PV-generated electric energy at time “t,” and sets the result of the subtraction as the supply-demand balanced electric energy.

If the third embodiment is combined with the second embodiment, step (S315B) further involves carrying out the following process as discussed in connection with step (S315A) of the second embodiment.

That is, if the device operation request data with “unspecified” set for the target consumer device C21 is registered in the device operation request group data T20, the operation planning part 222 acquires the values of the consumed electric power and consumed electric energy by referencing the operating conditions C23 of the device operation request data in question.

Furthermore, the operation planning part 222 updates the above-mentioned supply-demand balanced electric power with the value obtained by subtracting just the value of the consumed electric power. The operation planning part 222 updates the supply-demand balanced electric energy with the value obtained by subtracting exactly the value of the consumed electric energy.

(Fifth difference) From the input/output part 221 of the management apparatus 220, the input/output apparatus 210 can acquire via the communication network CN2 a screen through which to input the system electric power target data T100 and display the acquired screen. As with the above-described embodiments, the input/output apparatus 210 can further acquire, from the input/output part 221, data of input screens of the respective data including the device operation request group data T20, device electric power consumption characteristic data T30, storage battery characteristic data T40, PV power generation prediction data T50, and weather prediction data T60, and can display the acquired data.

By way of the communication network CN2 and input/output part 221, the management apparatus 220 acquires the data that has been input by the user to the input/output apparatus 210 through the above-mentioned input screens.

When the management apparatus 220 creates the device operation pattern T10 corresponding to the system electric power target data T100, the input/output apparatus 210 acquires the device operation pattern T10 from the input/output part 221 via the communication network CN2, and displays the acquired pattern T10.

The third embodiment configured as explained above offers the same advantages as the embodiments described earlier.

It may happen, for example, that the entire demand for the electric system suddenly increases to such an extent that the electric system as it is managed may become incapable of coping with that demand. In that case, the consumers may be asked temporarily to reduce their consumption of electric power. In such a situation, the consumer EMS 200 of the third embodiment can operate the consumer devices in a manner meeting the consumer's desires as much as possible while reducing the electric power used by the consumer.

If the system electric power upper limit and the system electric energy upper limit included in the system electric power target data T100 are each set to zero, the consumer EMS 200A of the third embodiment functions in the same manner as the consumer EMS 200 of the first or the second embodiment. That is, if the links to the power system have been severed, the consumer EMS 200A can suitably adjust the operation of the consumer devices within the power supplying capability possessed by the consumer.

### Fourth Embodiment

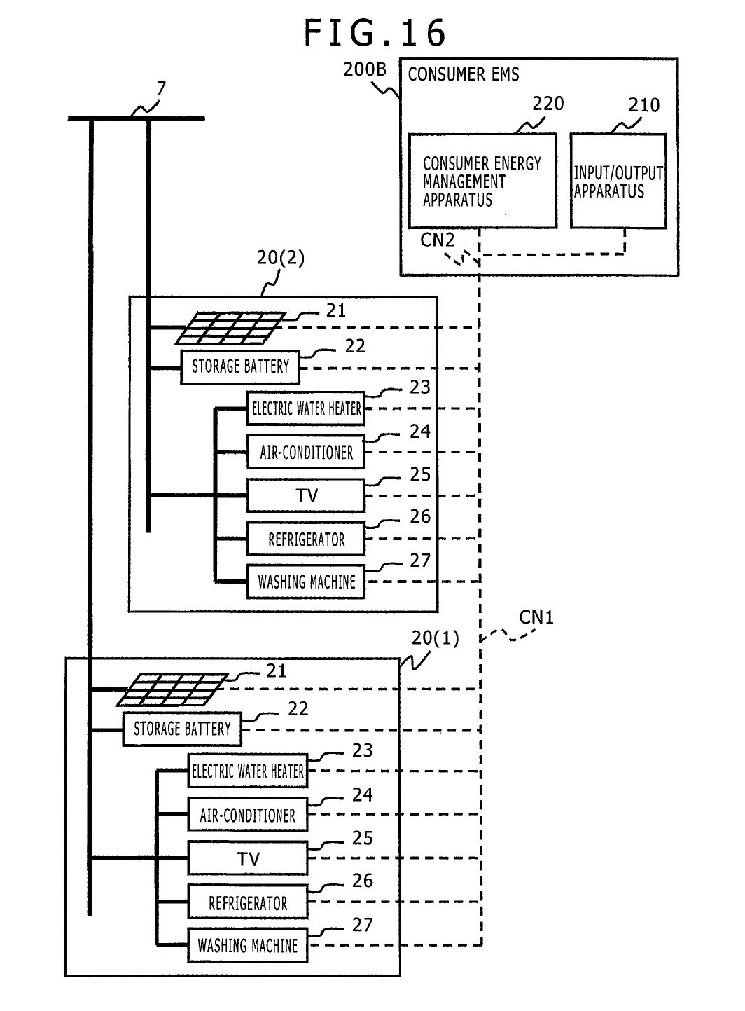

The fourth embodiment of the present invention is explained below with reference to FIG. 16. This embodiment deals with cases where a plurality of consumers are controlled in a unified fashion.

The examples in which a single consumer is involved were discussed above in conjunction with the first, the second, and the third embodiments. The configurations explained with these examples may be extended to a configuration aimed at multiple consumers. The consumer EMS 200B of the fourth embodiment is installed not for each consumer but for each group of a plurality of consumers.

FIG. 16 shows a typical configuration of devices associated with the consumer EMS 200B of the fourth embodiment. A plurality of consumers 20(1) and 20(2) are connected in a bidirectionally communicable fashion to the consumer EMS 200B via the communication network CN1.

For purpose of simplification and illustration, FIG. 16 shows an example involving the consumers 20(1) and 20(2) subordinated to the same low-voltage transformer in the power system. The consumers 20(1) and 20(2) make up a control target group for the consumer EMS 200B. The consumer EMS 200B performs energy management on the individual consumers 20(1) and 20(2) within the control target group. The number of grouped consumers is not limited to two; there may be three or more consumers constituting the group.

The consumers 20(1) and 20(2) are each furnished with the PV 21, storage battery 22, electric water heater 23, air-conditioner 24, TV 25, refrigerator 26, and washing machine 27. There is no need for each of these consumers 20(1) and 20(2) to possess the same consumer devices 21 through 27. The consumers may each have their own consumer device configuration.

The consumer EMS 200B of the fourth embodiment is configured in a manner different from the above-described embodiments in the points explained below. The consumer EMS 200B of this embodiment has a plurality of consumers 20(1) and 20(2) formed into a group to be dealt with as a single virtual consumer, as will be described hereunder.

(First difference) The device operation pattern T10, device operation request group data T20, device electric power consumption characteristic data T30, storage battery characteristic data T40, PV power generation prediction data T50, and weather prediction data T60 (as well as the system electric power target data T100) coming from the individual consumers within the target group are bundled by data type.

(Second difference) The consumer device monitoring part 223 acquires and manages the operating status data on the consumer devices of all consumers 20(1) and 20(2) within the target group.

(Third difference) The consumer device controlling part 224 transmits control signals for changing the operating status of the consumer devices to all consumers 20(1) and 20(2) within the target group.

(Fourth difference) The operation planning part 222 creates a plurality of device operation pattern candidates targeted for the consumer devices of all consumers 20(1) and 20(2) within the target group. The operation planning part 222 calculates the sum of the total goodness of fit of the individual consumers and uses the result of the calculation as the goodness of fit of the device operation pattern candidate. In the example of FIG. 16, the goodness of fit of the device operation pattern candidate is the sum of the total goodness of fit of the consumer 20(1) and the total goodness of fit of the consumer 20(2). From among the multiple device operation pattern candidates, the operation planning part 222 selects the candidate having the highest goodness of fit as the device operation pattern T10 to be applied to the virtual consumer {i.e., to the individual consumers 20(1) and 20(2) within the target group}.

(Fifth difference) The input/output apparatus 210 acquires planning data for inputting the data T20 through T60 (as well as the system electric power target data T100) regarding all consumers 20(1) and 20(2) within the target group from the input/output part 221 of the management apparatus 220 by way of the communication network CN2. The input/output apparatus 210 displays an input screen for these data.

The fourth embodiment configured as explained above offers the same advantages as the embodiments described earlier. The consumer EMS 200B of the fourth embodiment further proves to be advantageous when a certain geographical area is severed from the power system due to a disaster or like events to form an independent system. The consumer EMS 200B of this embodiment manages as one group the power sources (PV 21 and storage battery 22) within the independent system, and also manages as one group the electric loads 23 through 27 within the independent system.

The fourth embodiment thus allows the most important facilities (e.g., hospitals, shelters) of the community within the independent system to be operated preferentially. This embedment can suitably distribute electric power in the community having the consumers within the target group in it, improving the convenience of the community as a whole.

Even heavy-load devices that cannot be started or operated with a single storage battery 22 can be started and operated if multiple PV 21 and storage batteries 22 are controlled in a bundled fashion. This makes it possible preferentially to operate important devices such as medical equipment and disaster prevention equipment, for example.

### Fifth Embodiment

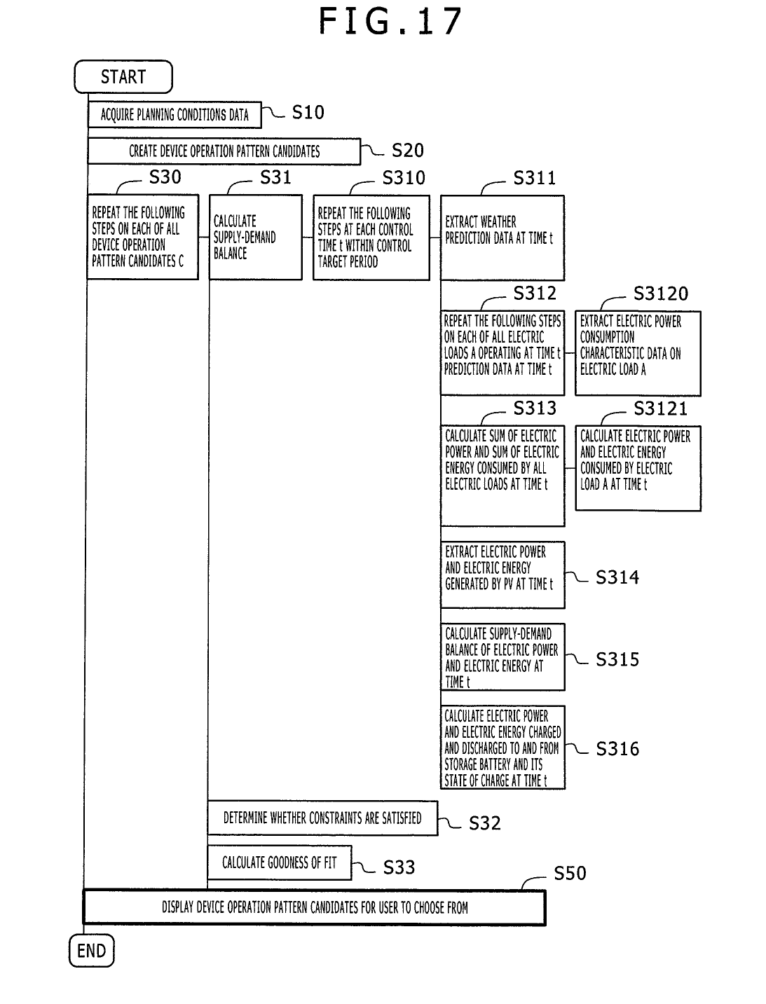

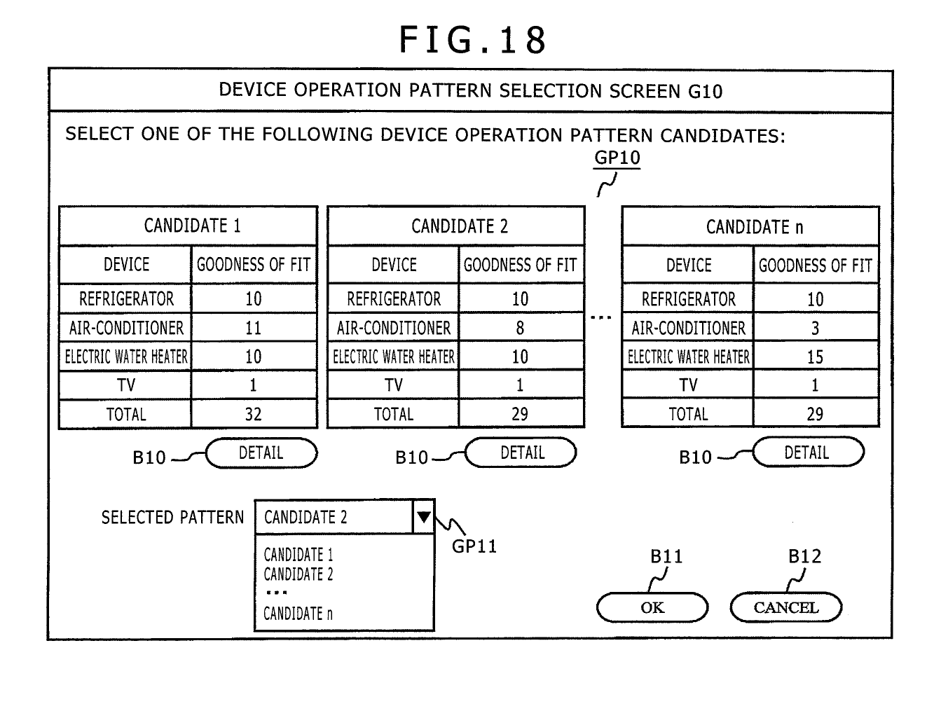

The fifth embodiment of the present invention is explained below with reference to FIGS. 17 and 18. This embodiment presents the user with information on a plurality of device operation pattern candidates, so that the consumer may select one of the candidates as the device operation pattern T10.

FIG. 17 shows a flow of the entire operations performed by the consumer EMS 200 of the fifth embodiment. In step (S50), the user is presented with the information on multiple device operation pattern candidates, so that the user may select one of the candidates.

FIG. 18 shows a typical screen G10 on which the user selects one of the device operation pattern candidates as the device operation pattern T10. The data in the screen G10 is created by the management apparatus 220 and transmitted from the input/output part 221 to the input/output apparatus 210 via the communication network CN2 before the data is displayed on the input/output apparatus 210. The result of the selection made by the user is transmitted from the input/output apparatus 210 to the management apparatus 220 via the communication, network CN2 and input/output part 221.

The device operation pattern selection screen G10 is configured to include a candidate information display part GP10, a pattern selection part GP11, and a plurality of buttons B10, B11 and B12, for example.

The candidate information display part GP10 displays information on a plurality of device operation pattern candidates. For example, the candidate information display part G10 may display the goodness of fit of the individual device operation pattern candidates. When the user operates a DETAIL button B10 corresponding to each of the device operation pattern candidates, the operating status of the candidate at each control time within the control target period, such as those explained in relation to FIG. 5 for example, is displayed.

Referencing the information displayed on the candidate information display part GP10, the user selects one of the candidates as the device operation pattern T10 and inputs the selected candidate to the pattern selection part GP11. When the user operates the OK button B11, the selected device operation pattern is registered in the data management part 225 of the management apparatus 220. If the user operates the CANCEL button B12, the device operation pattern selection screen G10 can be remade. For example, the user can modify part or all of the device operation request group data to again create a device operation pattern candidate.

The fifth embodiment configured as explained above allows the users themselves to select the device operation pattern T10, enhancing the users' convenience. This embodiment is applicable to the second, the third, the fourth, and the fifth embodiments. Further, it may be arranged that either automatic selection mode or manual section mode is selected; that the first embodiment is applied when automatic selection mode is selected; and that the fifth embodiment is applied when manual selection mode is selected.

The present invention is not limited to the above-described embodiments. Those skilled in the art may make various additions and modifications to the present invention within the spirit and scope thereof.

For example, the present invention may also be expressed in the form of a computer program described as follows:

“A computer program for causing a computer to function as a consumer energy management system for managing operating status of devices possessed by a consumer, the computer program causing the computer to implement the functions including:

an information acquisition part which acquires operation request information indicative of requests with regard to the operating status of at least one device at predetermined intervals, and device electric power characteristic information indicative of information on the power consumed or generated by the device;

a device operation pattern candidate creation part which creates a plurality of device operation pattern candidates indicative of the operating status of the device at predetermined intervals, and

an evaluation part which evaluates the plurality of device operation pattern candidates on the basis of the operation request information and on the device electric power characteristic information.”

The present invention may also be expressed, as another example, in the form of a consumer energy management apparatus described as follows:

“A consumer energy management apparatus for managing operating status of devices possessed by a consumer, the apparatus including:

an input/output part connected in bidirectionally communicable fashion to an input/output apparatus for inputting and outputting information;

an information acquisition part which acquires operation request information indicative of requests with regard to the operating status of at least one device at predetermined intervals, and device electric power characteristic information indicative of information on the power consumed or generated by the device, from the input/output apparatus via the input/output part;

a device operation pattern candidate creation part which creates a plurality of device operation pattern candidates indicative of the operating status of the device at predetermined intervals, and

an evaluation part which evaluates the plurality of device operation pattern candidates on the basis of the operation request information and on the device electric power characteristic information.”

### REFERENCE NUMERALS

20 Consumer
200 Consumer EMS
210 Input/output apparatus
220 Consumer energy management apparatus
21 Photovoltaic apparatus
22 Storage battery
23-27 Electric loads

1. A consumer energy management system configured to manage operating status of a device possessed by a consumer, the system comprising:
an information acquisition part which acquires operation request information indicative of request with regard to the operating status of at least one device at a predetermined interval, and device electric power characteristic information indicative of information on power consumed or generated by the device;
a device operation pattern candidate creation part which creates a plurality of device operation pattern candidates indicative of the operating status of the device at the predetermined interval, and
an evaluation part which performs evaluation on the plurality of device operation pattern candidates on a basis of the operation request information and of the device electric power characteristic information.

2. The consumer energy management system according to claim 1, further comprising a selection part which selects one of the plurality of device operation pattern candidates as a device operation pattern on a basis of a result of the evaluation.

3. The consumer energy management system according to claim 2, wherein the evaluation part calculates goodness of fit between the plurality of device operation pattern candidates and the operation request information, and determines whether supply of electric power to the consumer is larger than electric power used by the device.

4. The consumer energy management system according to claim 4, wherein, if the supply of the electric power to the consumer is larger than the electric power used by the device, the evaluation part evaluates, the device operation pattern candidates in terms of the goodness of fit where the higher the goodness of fit of a device operation pattern candidate is, the higher the device operation pattern candidate is evaluated.

5. The consumer energy management system according to claim 4, wherein the selection part selects, among the plurality of device operation pattern candidates, a device operation pattern candidate most highly evaluated by the evaluation part as the device operation pattern.

6. The consumer energy management system according to claim 5, wherein:
the operation request information is structured to include device identification information for identifying the device, target period information indicative of a period in which the device is operated, operating condition information indicative of the operating condition of the device, and request level information indicative of a request level of operation of the device; and
the evaluation part calculates the goodness of fit through adding up the request level when the operating condition is met.

7. The consumer energy management system according to claim 6, wherein a control signal is transmitted to the device in order to operate the device in accordance with the device operation pattern selected by the selection part.

8. The consumer energy management system according to claim 3, wherein the supply of electric power to the consumer is the supply of power from a power supply apparatus possessed by the consumer.

9. The consumer energy management system according to claim 3, wherein the supply of electric power to the consumer is the supply of electric power within a predetermined value from a power system to the consumer.

10. The consumer energy management system according to claim 3, wherein supply of electric power to the consumer is a sum of the supply of the electric power from a power supply apparatus possessed by the consumer and the supply of the electric power within a predetermined value from a power system to the consumer.

11. The consumer energy management system according to claim 1, wherein:
the consumer includes a plurality of consumers; and
each of the plurality of consumers possesses at least one device.

12. The consumer energy management system according to claim 1, further comprising an output part which outputs evaluation by the evaluation part.

13. The consumer energy management system according to claim 12, further comprising an input part which allows the consumer to select one of the plurality of device operation pattern candidates as the device operation pattern on a basis of the evaluation output from the output part.

14. The consumer energy management system according to claim 7, further comprising:
a consumer energy management apparatus which is connected to the device and manages consumer energy, and
an input/output apparatus which inputs and outputs information to and from the management computer, wherein the consumer energy management apparatus includes:
a consumer device monitoring part which monitors the operating status of the device;
a consumer device operation planning part which creates the device operation pattern;
a consumer device controlling part which transmits the control signal to the device, and
an information management part which stores at least the operation request information and the device electric power characteristic information, wherein:
the consumer device operation planning part includes the information acquisition part, the device operation pattern candidate creation part, the evaluation part, and the selection part; and
the consumer device operation planning part presents the consumer with the plurality of device operation pattern candidates via the input/output apparatus.

15. A consumer energy management method for managing operating status of a device possessed by a consumer by means of a consumer energy management apparatus, the method causing the consumer energy management apparatus to execute:
an information acquisition step which acquires operation request information indicative of requests with regard to the operating status of at least one device at a predetermined interval, and device electric power characteristic information indicative of information on the power consumed or generated by the device;
a candidate creation step which creates a plurality of device operation pattern candidates indicative of the operating status of the device at the predetermined interval; and
an evaluation step which evaluates the plurality of device operation pattern candidates on a basis of the operation request information and of the device electric power characteristic information.
